(19) United States
(12) Patent Application Publication
(10) Pub. No.: US 2009/0216616 A1
(43) Pub. Date: Aug. 27, 2009

(54) Method and System for Displaying Correlated Advertisements to Internet Users

(76) Inventors: Yang Wang, Union City, CA (US); Sam Peter Hamilton, Los Altos, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/037,685

(22) Filed: Feb. 26, 2008

(51) Int. Cl. G06Q 30/00

(52) U.S. Cl. 705/10; 705/14

(57) ABSTRACT

Broadly speaking, the present invention fills the need of selecting correlated advertisements for displaying to users by utilizing the advertisement-viewing data collected on users of a web site. The advertisement-viewing (ad-viewing) data of users of a web site can be correlated to extract similarities and patterns of ads being viewed by users of the web site. The correlated ad-viewing data of all users of the web site, along with URLs (Uniform Resource Locators) of ads viewed by a particular user, can be used to select advertisements that are likely to be interests to the particular user. Ad-viewing data correlation allows the web site to select ads to display to users in real-time based on users' latest ad-viewing data. Since selection of ads to display is based on mathematical calculation using a correlation table of ad-viewing that has been generated ahead of time, the method can be scaled to meet demands of a large amount of users, such as millions. In addition to ad-viewing correlation table and users' latest ad-viewing data, advertisement pool of advertisements paid by advertisers is also taken into consideration during the ad-selection process.

### BACKGROUND OF THE INVENTION

1. Field of the Invention

This invention relates generally to displaying of advertisements to Internet users, and more particularly, displaying correlated advertisements to Internet users.

2. Description of the Related Art

On-line advertising may be used by advertisers to accomplish various business goals, ranging from building brand awareness among potential customers to facilitating on-line purchases of products or services. A number of different kinds of page-based or video-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement.

An example of on-line advertisements is banner advertisement (or ad). A banner advertisement typically features an image (animated or static) and/or text displayed at a predetermined position in a page. The banner advertisement usually takes the form of a horizontal rectangle at the top of the page, but it can also be arranged in a variety of other shapes at any other location on the page. If a user clicks on the banner advertisement's location, image, and/or text, the user is taken to a new page that may provide detailed information regarding the products or services associated with the banner advertisement. Banner advertisements are often provided on a guaranteed number of impressions basis, though they may also be performance-based. Other types of on-line advertisements, such as pop-up ads, text ads, and video ads, also exist. Pop-up ads appear in new web browser windows when a user accesses a new web page. Text ads appear alongside search results and are related to the search word(s) entered by the user. Video ads play videos when users open new web pages or when users click on the video ads.

Most of the on-line advertisements are not effective in reaching the on-line users because the advertisers have no knowledge or limited knowledge of the users or the users' interests. The advertisers often can only target the advertisements based on the vague understanding of the demographics of users viewing certain web sites or pages. Therefore, most of on-line advertisements are either not targeted at all, or not targeted effectively. Since on-line advertisements are presented to Internet users with little or no knowledge of the Internet users, the chances for the Internet users to be interested in the advertisements are small. And, most users that are on-line simply choose to ignore a majority of on-line advertisements.

In view of the foregoing, there is a need for methods and systems for selecting advertisements to display to users, and that users would find the selected advertisements relevant and/or of interests to them. When users find the selected advertisements, which are displayed to them, relevant and/or of interests to them, the users are more likely to view the advertisements.

### SUMMARY OF THE INVENTION

Broadly speaking, the present invention fills the need of selecting correlated advertisements for displaying to users by utilizing the advertisement-viewing data collected on users of a web site. The advertisement-viewing (ad-viewing) data of users of a web site can be correlated to extract similarities and patterns of ads being viewed by users of the web site. The correlated ad-viewing data of all users of the web site, along with URLs (Uniform Resource Locators) of ads viewed by a particular user, can be used to select advertisements that are likely to be interests to the particular user. Ad-viewing data correlation allows the web site to select ads to display to users in real-time based on users' latest ad-viewing data. Since selection of ads to display is based on mathematical calculation using a correlation table of ad-viewing that has been generated ahead of time, the method can be scaled to meet demands of a large amount of users, such as millions.

In addition to ad-viewing correlation table and users' latest ad-viewing data, advertisement pool of advertisements paid by advertisers is also taken into consideration during the ad-selection process.

It should be appreciated that the present invention can be implemented in numerous ways, including as a method, a system, or a device. Several inventive embodiments of the present invention are described below.

In one embodiment, a method of selecting at least one advertisement to display in a web page of a user of a web site is provided. The method includes receiving the user's request to open the web page of the web site. The method also includes sending an identity of the user to identify a Uniform Resource Locator (URL) of at least one advertisement recently viewed by the user. The method further includes selecting a correlated URL of the at least one advertisement to display in the web site. The correlated URL of the at least one advertisement correlates to the identified URL of the at least one advertisement recently viewed by the user using an ad correlation table of advertisements viewed by users of the web site. In addition, the method includes displaying the at least one advertisement of the correlated URL being selected in the web page of the user of the web site.

In another embodiment, a system for selecting advertisements to display in a web page of a user of a web site is provided. The system includes a user profile server for identifying the user. The system also includes a user ad-viewing history server for storing ad-viewing histories of users to the web site. The user ad-viewing history server provide Uniform Resource Locators (URLs) of advertisements recently viewed by the user. The system further includes an instant advertisement suggestion server having an ad correlation table that correlates advertisements viewed by users of the web site. The instant advertisement suggestion server takes URLs of advertisements recently viewed by the user as inputs and uses the ad correlation table to select correlated URLs of advertisements to be displayed in the web page correlating with URLs of advertisements recently viewed by the user. In addition, the system includes an ad server using the correlated URLs of advertisements being selected to prepare advertisements to display in the web page of the user.

In yet another embodiment, computer readable media including program instructions for selecting at least one advertisement to display in a web page of a user of a web site are provided. The computer readable media include program instructions for receiving the user's request to open the web page of the web site. The computer readable media further include program instructions for sending an identity of the user to identify a Uniform Resource Locator (URL) of at least one advertisement recently viewed by the user. In addition, the computer readable media include program instructions for selecting a correlated URL of the at least one advertisement to display in the web site. The correlated URL of the at least one advertisement correlates to the identified URL of the at least one advertisement recently viewed by the user using an ad correlation table of advertisements viewed by users of the web site. Additionally, the computer readable media include program instructions for displaying the at least one advertisement of the correlated URL being selected in the web page of the user of the web site.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a diagram of demand prediction, in accordance with one embodiment of the present invention.

FIG. 2 shows a web site providing information and/or services to users, in accordance with one embodiment of the present invention.

FIG. 3 shows a web page being viewed by a User-N, in accordance with one embodiment of the present invention.

FIG. 4A shows a table correlating users with the URLs of ads visited by the users, in accordance with one embodiment of the present invention.

FIG. 4B shows number of visits of URLs of two ads by two users, in accordance with one embodiment of the present invention.

FIG. 4C shows a correlation angle between URLs of two ads, in accordance with one embodiment of the present invention.

FIG. 4D shows number of visits of URLs of two ads by two users, in accordance with one embodiment of the present invention.

FIG. 4E shows a correlation angle between URLs of two ads, in accordance with one embodiment of the present invention.

FIG. 4F shows a correlation table between URLs of ads viewed by users, in accordance with one embodiment of the present invention

FIG. 5A shows a system of a user interacting with a web site, in accordance with one embodiment of the present invention.

FIG. 5B shows an ad correlation table, in accordance with one embodiment of the present invention.

FIG. 6A shows an ad selection system with key components of selecting ads for a user, in accordance with one embodiment of the present invention.

FIG. 6B shows a web page with content and ads, in accordance with one embodiment of the present invention.

FIG. 6C shows a process flow of a user accessing a web page with ads, which are selected by correlating User-1's recent ad-viewing activities with ad-viewing activities of other users, in accordance with one embodiment of the present invention.

### DETAILED DESCRIPTION

Broadly speaking, the present invention fills the need of selecting correlated advertisements for displaying to users by utilizing the advertisement-viewing data collected on users of a web site. The advertisement-viewing (ad-viewing) data of users of a web site can be correlated to extract similarities and patterns of ads being viewed by users of the web site. The correlated ad-viewing data of all users of the web site, along with URLs (Uniform Resource Locators) of ads viewed by a particular user, can be used to select advertisements that are likely to be interests to the particular user. Ad-viewing data correlation allows the web site to select ads to display to users in real-time based on users' latest ad-viewing data. Since selection of ads to display is based on mathematical calculation using a correlation table of ad-viewing that has been generated ahead of time, the method can be scaled to meet demands of a large amount of users, such as millions. In addition to ad-viewing correlation table and users' latest ad-viewing data, advertisement pool of advertisements paid by advertisers is also taken into consideration during the ad-selection process.

When a user visits a web site or accesses a web site to view web pages, advertisements often appear along with the content that the user is trying to access. The user could be researching information about a particular illness, reading daily news, or conducting on-line search for a particular product to purchase. While the user is reading the information (or content) on the web page, the user would often glance at the advertisements appear on the web page. The user would click on advertisements that appear to be of interest to the user. The history of advertisements viewed by the user provides information on the types of advertisements that the user is interested in.

A user's interest in different ads changes with time. The user might need to buy a car at the end of last year and viewed quite a few auto-related advertisements during that period. The user might need to buy a present to a baby shower last month and viewed a few ads related to presents for infants. The user's advertisement-viewing (ad-viewing) behavior changes with time and the purchasing need of the user. A user's need(s) to purchase certain product(s) and/or service(s) often stay for a period of time until the need(s) of purchasing is fulfilled. Before the need(s) is met, the user's interests in the product(s) and/or service(s) remain.

In addition, a user's affinity of ads is affected by the user's income, gender, education, and other backgrounds. Users with similar backgrounds tend to exhibit similar ad-viewing behaviors. Examining the ad-viewing data of users' ad-viewing data of a web site can find patterns or similarities of different groups (or types) of users, depending on their backgrounds. For example, software engineers might be interested in ads related to games, game equipments, Starbucks coffee, Fry's, etc. Correlation of ad-viewing data can reveal the common interests in ads for users with similar background. Finding out what types of ads people with similar background to the users are interested in can provide clues to what types of ads, that are related to the recent ads (recent interests) viewed by the users, might be of interests to the users.

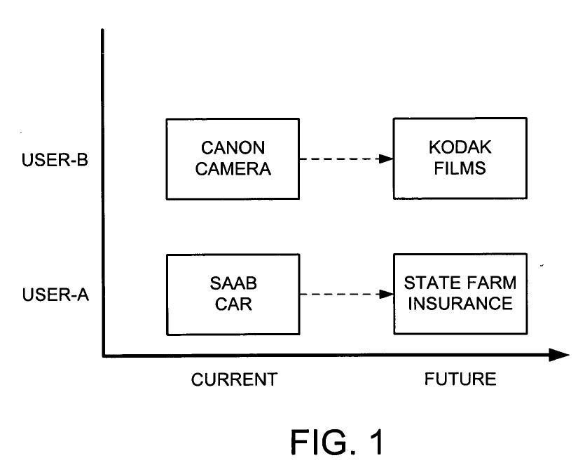

In addition to finding ads that are of current interests to the users, correlation of ad-viewing data of uses can also reveal future interests (or predicted demands) of the users. FIG. 1 shows a diagram of demand prediction, in accordance with one embodiment of the present invention. When a User-A views web pages to seek information on a new or used SAAB car, the user could be considering purchasing such a car. The web page could be a product description page created by SAAB, which is a car company, or a product comment page created by Consumer Report, which is a consumer service company. User-A could be viewing the web pages to gather information on the car to purchase such a car. One can imagine that after User-A purchases a SAAB car, User-A would need to purchase car insurance, such as a car insurance offered by State Farm Insurance, for the newly purchased SAAB car. The future demand in ads related to car insurance of User-A is related to the past ad-viewing behavior of User-A. FIG. 1 also shows another example of a User-B who was clicking and viewing a toy page on the Toys R Us web site. User-B could be reviewing the information on the toy page to purchase a toy for a child. User-B could be buying the toy as a birthday present for the child. Since User-B is interested in purchasing a toy for the child, User-B might be interested in purchasing kid cloth for the child as an alternative birthday present. The examples in FIG. 1 show that users' ad viewing needs (or ad demand) can be predicted. The ad-viewing history of a user and ad-viewing histories of users with backgrounds similar to the user can be used to predict the user's future demand of advertisements. Finding out a user's demand for advertisement based on the user's ad-viewing history and other users' ad-viewing histories is called “demand prediction”.

Predicting users' ad-viewing demand relies on a lot of users' ad-viewing historical data. It's difficult to predict a User-X's demand of advertisements based on limited information of User-X. The more information of User-X's ad viewing history, the better it is to be able to predict User-X's demand for other ads. As mentioned above, the information that can be used to predict User-X's demand of ad is not limited to the ad-viewing history of User-X. Ad-viewing histories of other users, especially other users with similar or related backgrounds with User-X, can also be used to gain insight into what types of ads User-X might be interested in. A web site can collect ad-viewing data of all users that visited the web site to find the similarities and patterns among different users.

A web site that offers many different kinds of information and services, such as Yahoo!, can gather ad-viewing histories of many users. For example, Yahoo! currently has millions of users who access the Yahoo! web site and the tools provided by the web site on a daily basis. While these millions of users access the information and/or tools of the web site, many of these users view ads that appear in the web pages. The ad-viewing histories of these millions users can be captured and correlated to find similarities of these users. As mentioned above, users with similar backgrounds, such as education, jobs, geographical location, gender, or age etc., tend to exhibit similar ad-viewing behavior. Correlating the ad-viewing data of different users allows the web site to identify these similarities to predict users' future demand for ads. Collecting ad-viewing data to identify users' future demands is not limited to large web sites. Smaller sites can also perform similar tasks.

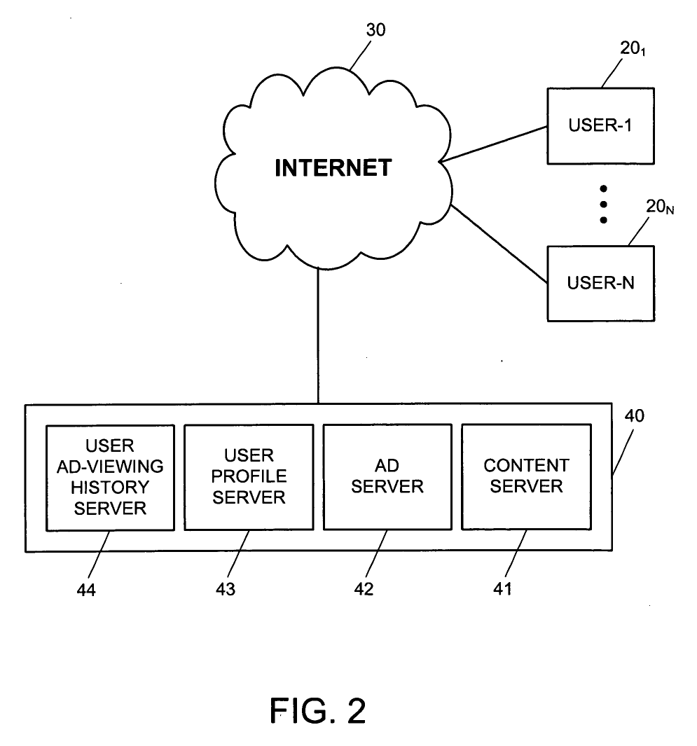

FIG. 2 shows a web site 40 that provides information and/or services to users that include User-1 20₁ to User-N 20_{N}, in accordance with one embodiment of the present invention. The number N can be as large as millions, or even billions. The examples of the information provided by web site 40 include, but not limited to, finance, daily news, jobs, and sports, etc. The examples of services provided by web site 40 include, but not limited to, web space for networking groups, map search, and instant messages, etc. An example of web site 40 is the Yahoo! site, which provides various types of information, such as Yahoo! Finance and Yahoo News, and services, such as Yahoo! Groups, Yahoo! Maps and Yahoo! Shopping, to Internet users.

As shown in FIG. 2, web site 40 has a Content Server 41 that provides informational contents to users, such as User-1 20₁ to User-N 20_{N}. The informational contents provided to the users can include many types of information, such as weather, finance, daily news, messages of online groups, search results, etc. The Content Server 41 is coupled to an Ad Server 42, which provides ads to display along with the informational contents to users. A web page served by a web site, such as Yahoo!, normally includes informational contents and ad(s).

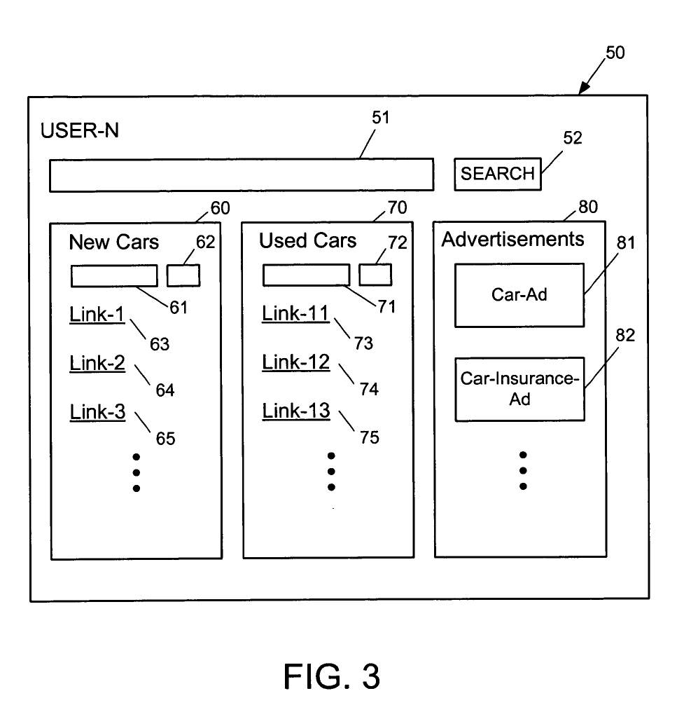

Advertisements often appear along with informational contents in a web page to a user. FIG. 3 shows a web page 50 being viewed by User-N, in accordance with one embodiment of the present invention. Web page 50 is generated after User-N pushes an “Auto” category in the Yahoo! main page. User-N is interested in finding out information related to autos and selects the “Auto” category from Yahoo! main page to read information regarding autos. Web page 50 has a search box 51, which allows User-N to enter search word or phrase, and a search button 52, which User-N can push to launch the search. Web page 50 also has an information area 60 related to new cars. In the information area 60, there is a search box 61 and a “go” button 62, which can be pushed after User-N enters the search words to initiate the search on new cars. Information area 60 also has a number of links, such as Link-1 63, Link-2 64, and Link-3 65. Web page 50 further has an information area 70 related to used cars. In the information area 70, there is a search box 71 and a “go” button 72, which can be pushed after User-N enters the search words to initiate the search on used cars. Information area 70 also has a number of links, such as Link-11 73, Link-12 74, and Link-13 75. Next to the information area 70, there is an advertisement area 80. In advertisement area 80, there is a Car-Ad 81 and a Car-Insurance-Ad 82. More advertisements could be displayed below Car-Insurance-Ad 82.

Web site 40 also has a User Profile Server 43 that stores and manages users' profiles. Users' profiles can include, but not limited to, information such as users' genders, ages, geographical locations, email addresses, and cookies of the users, etc. A web site often uses cookies to identify users. Further, web site 40 has a User Ad-Viewing History Server 44, which stores the ad-viewing histories of all users to web site 40. The information stored in the User Ad-Viewing History Server 44 can include, but not limited to, the dates and time, and the URLs (Uniform Resource Locators) of ads the users clicked and viewed, etc. For example, User-N clicks Link-1 63 first to view the content of Link-1. After viewing the content of Link-1, User-N clicks and views the content of Car Ad 81. Web site 40 uses a cookie installed on User-N's computing system to link the person viewing the information content of Link-1 and Car ad 81 as being User-N. Link-1 and Car ad 81 are associated and identified by URLs. Web site 40 can record the identify of User-N, the dates and time when User-N views Link-1 63 and Car-Ad 81 in the User Viewing History Server 44.

Many users, such as millions of users, visit web site 40. Their online ad-viewing activities can be recorded in the User Ad-Viewing History Server 44. The data stored in the User Ad-Viewing History Server 44 can be correlated to find patterns of user's advertisement-viewing activities. The patterns can be used to identify advertisements that might be of interests to the users in the future. For example, if many users who viewed ads related to cars also viewed ads related to car insurance. The ad-viewing histories of users would show such a correlation. Therefore, when a User-M views a car ad, it would b a good idea to display car insurance ad(s) to User-M.

Web sites and/or market research firms study the users' ad-viewing histories data collected by web sites. Some of the ad-viewing studies involve human beings analyzing and correlating the data to determine what types of ads to serve to different groups of users, which are called behavior targeting. Behavior targeting involves human interpretation, which is expensive, can be biased and/or vary from person to person. In addition, behavior targeting can only be done periodically offline, and cannot be performed in real-time based on the current web usage of users. For example, if a user views an advertisement within the last few seconds to buy a pair of shoes. This information cannot be used instantly to select an advertisement related to shoe buying of the user to keep the user on the same or related subject(s) of “shoe-buying”, based on behavior targeting.

Alternatively, there are ad-viewing pattern studies that involves software, or using computer codes, which involves less (or much less) human interpretation and analysis. However, using software, or computer codes, to study patterns of ad-viewing often involves analyzing the contents of the ads the users viewed. For example, the software, or computer codes, would search (or find) key words in the ad pages or tags of the ad page, to find out the topics or subjects of the ads to gain understanding of the users and the users' ad-viewing behaviors. Such analysis by software, or computer codes, that involves studying the contents of ad pages can be performed in real-time; however, it's difficult to scale since searching for key words in the ad pages or tags takes time and computing resources for large number of users. Contrary to behavior targeting, the software might be able to use the “shoe-buying” ad-viewing information of the user mentioned in the last paragraph instantly to bring up an ad that is currently relevant to the user. However, since the process involves analyzing the content of advertisement(s) of the users to understand the current ad-viewing activities of users, such as a user viewing “shoe-buying” related ads, the process is difficult to scale to a large number of users to provide instant suggestions of web ads, based on users' ad-viewing data in the last few seconds.

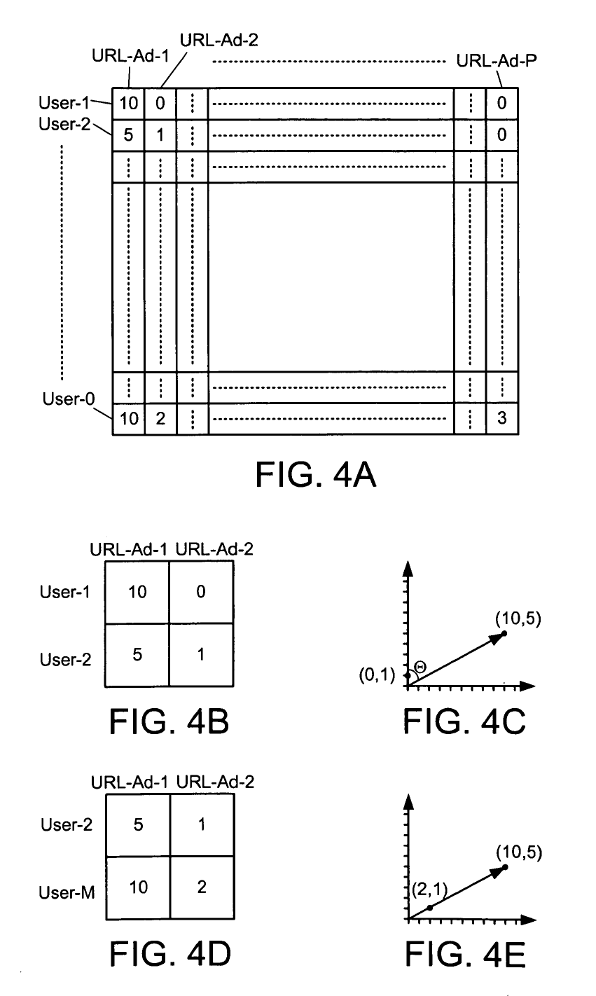

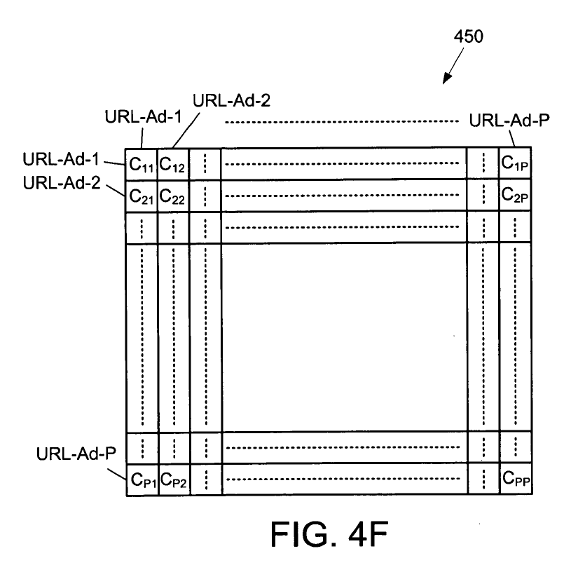

The embodiments of the current invention involve using the URLs of the ads viewed the users to directly correlate users' ad-viewing patterns. The directly correlation does not involve reading or analyzing the contents or key words in the ads. FIG. 4A shows a table 400 correlating users with the URLs of ads visited by the users, in accordance with one embodiment of the present invention. FIG. 4A shows the table 400, which correlates the number of visits by users, such as User-1, User-2, . . . to User-O, with the URLs, such as URL-Ad-1, URL-Ad-2, . . . to URL-Ad-P, of ads the users viewed. The values O and P can be any integer number. In the example of FIG. 4A, User-1 viewed URL-Ad-1 10 times, URL-Ad-2 zero time, and URL-Ad-P zero time. User-2 viewed URL-Ad-1 5 times, URL-Ad-2 1 time and URL-Ad-P zero time. User-O viewed URL-Ad-1 10 time, URL-Ad-2 3 times, and URL-Ad-P 3 times. The data in Table 400 reveal which URLs are viewed by what users for how many times and shows the relationship between the URLs of ads with the users who view them.

Table 400 of FIG. 4A can be rearranged to show the relationship between URLs of ads. For example, the relationship between URL-1, URL-2, URL-Ad-1 and URL-Ad-2 is displayed in FIG. 4B. URL-Ad-1 has been visited by User-1 for 10 times and by User-2 for 5 times, and URL-Ad-2 has been visited by User-1 for 0 time and by User-2 for 1 time. The data in FIG. 4B suggests that URL-Ad-1 is relatively more popular to User-1 and User-2 than URL-Ad-2. The data suggests relatively weak correlation between URL-Ad-1 and URL-Ad-2. There are many different ways to show the correlation between URL-Ad-1 and URL-Ad-2. One of the ways is by using a “cosine” function. FIG. 4C shows the coordinate of numbers of views for URL-1 (10,5) and URL-2 (0,1) by the number of visits by User-1 and User-2. The angle between these two coordinates is represented by correlation angle θ. If the correlation between URL-1 and URL-2 is very strong, the correlation angle θ would be very small and cosine (θ) would be close to one. In contrast, if the correlation is very weak, the angle θ would be close to 90° and cosine (θ) would be close to zero. In the example of FIGS. 4B and 4C, the angle is about 63° (or cosine (θ)=0.45), which suggests a relatively weak correlation between URL-Ad-1 and URL-Ad-2 for User-1 and User-2. In contrast, FIG. 4D shows a correlation Table between URL-Ad-2 and URL-Ad-P, based on data of User-2 and User-O. The correlation angle between URL-Ad-2 and URL-Ad-P being zero degree (or cosine (θ)=1) between User-2 and User-O, as shown in FIG. 4E.

The correlation angles θ in FIGS. 4C and 4E are only between two users, User-1 and User-2. When there are a large number of users, the cosine value between two ads can be calculated by dot product of vectors. Each URL of an ad, such as URL-Ad-1, URL-Ad-1, . . . , to URL-Ad-P, can be represented by a vector of hits by all users, from User-1 to User-O. For example, URL-Ad-1 can be expressed as a vector as shown in vector (1) below.

URL-Ad-1=<10, 5, . . . , 10 > (1)

URL-Ad-2 can be expressed as a vector as shown in vector (2) below.

URL-Ad-1=<0, 1, . . . , 2> (2)

In mathematics, the inner product of two vectors, “A” and “B”, and the cosine of angle θ between these two vectors can be expressed in equation (3) below.

A·B=∥A∥∥B∥ cosine(θ) (3)

Where A=(A₁, A₂, A₃, . . . Aₙ), B=(B₁, B₂, B₃, . . . Bₙ), and ∥A∥ and ∥B∥ are the lengths of vectors A and B. The inner product of A and B can be calculated by equation (4) below.

A·B=(A₁, A₂, A₃, . . . Aₙ)·(B₁, B₂, B₃, . . . Bₙ)=A₁B₁+A₂B₂+ . . . +AₙBₙ (4)

The lengths of vectors A and B, ∥A∥ and ∥B∥, can be calculated by equations (5) and (6) below.

∥A∥=sqrt(A₁²+A₂²+A₃²+ . . . +Aₙ²) (5)

∥Bμ=sqrt(B₁²+B₂²B₃²+ . . . +Bₙ²) (6)

As described above, if the correlation between the two URLs is strong, the cosine value calculated would be close to 1 (θ close to 0°). On the other hand, if the correlation is very weak (θ close to 90°), the cosine value calculated would be close to zero.

Based on the calculation above, a correlation table 450 between URLs can be constructed, as shown in FIG. 4F, in accordance with one embodiment of the present invention. The numbers in table 450 are correlation factors, C₁₁, C₂₁, . . . , to C_{PP}, between the URLs. In one embodiment, the factors are values between 0 and 1, which are cosine of correlation angles between the URL of ad in the horizontal row to the URL of ad in the vertical column. For example C₂₁ is the correlation factor between URL-Ad-2 to URL-Ad-1 and is calculated based on the number of visits by users to the two ads linked to URL-Ad-2 and URL-Ad-1. A correlation factor with value close to 1 suggests a very good correlation and a value close to zero suggests a very poor correlation. The correlation factors of ads with themselves, C₁₁, C₂₂, C₃₃, . . . , to C_{PP}, are all 1, since each ad directly correlates to itself.

Table 450 can be pre-calculated using users' ad-viewing data stored in one or more servers, such as User Ad-Viewing History Sever 44 of FIG. 2 described above. Table 450 can be calculated (or generated) in different frequencies depending on the need of the web site. For example, Table 450 can be calculated (or generated) on a daily, weekly, or monthly basis. A web site, such as web site 40, can use the newest (or latest) user ad-viewing data collected by the web site, such as data collected in the last few days, weeks, or months, to generate the correlation table. Users' interests, and tastes in ads, and trends, styles, and media for advertisements change with time. The more recent the data of users' ad-viewing are used, the better and more relevant the correlation table will be.

Table 450 can be used in real-time to suggest URLs of ads to users utilizing URLs of ads recently viewed by the users. For example, User-1 has just viewed URL-Ad-1, URL-Ad-5 and URL-Ad-99 within the last few seconds or last minutes. One can assume that the subjects in the ads in URL-Ad-1, URL-Ad-5 and URL-Ad-99 are currently of interests to User-1. It's important suggests advertisements related to these ads to User-1. The ways to find advertisements, which are identified by URLs, of interests to User-1 is by using the correlation of URLs of ads, such as the correlation shown in Table 450.

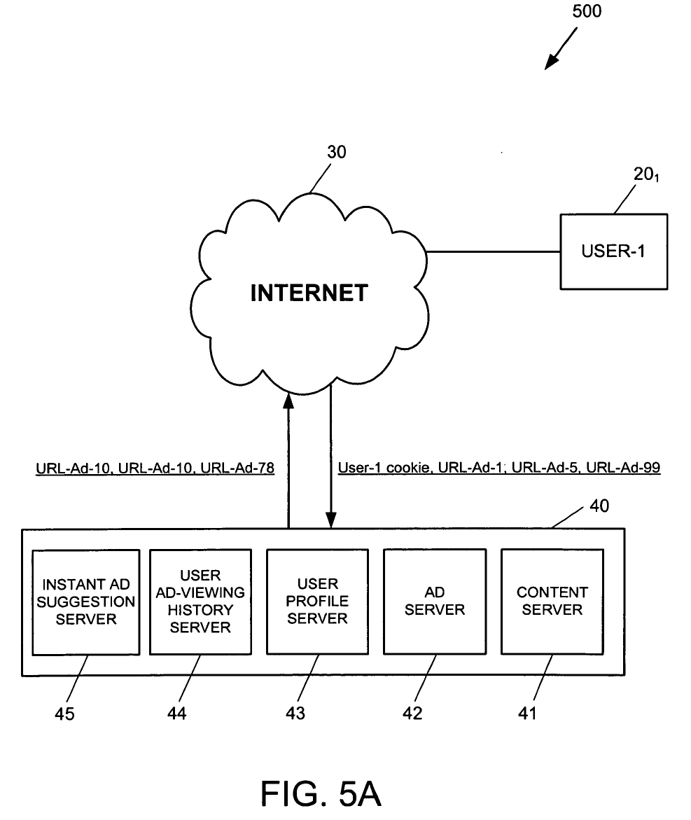

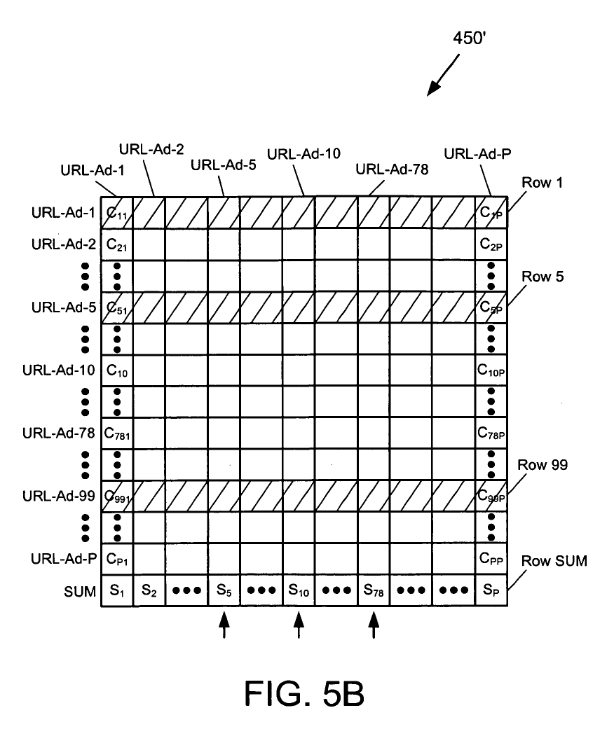

FIG. 5A shows a system 500 of a User-1 20₁ interacting with a web site 40, in accordance with one embodiment of the present invention. User-1 has recently viewed ads having URLs, URL-Ad-1, URL-Ad-5 and URL-Ad-99, within the last few seconds or last minutes. These URLs, along with a cookie identifying User-1, are sent to web site 40. The URLs and the cookie can be sent in a single message or multiple messages. In one embodiment, the cookie is analyzed by the User Profile Server 43 to identify the user being User-1. The URLs are used by an Instant Ad Suggestion Server 45 to provide (or suggest) URLs of ads to be presented to User-1. In one embodiment, the instant URL the Instant Ad Suggestion Server 45 has stored the table 450 described above. The Instant Ad Suggestion Server 45 uses URL-Ad-1, URL-Ad-5, and URL-Ad-99 as inputs to make computation to generate a number of URLs, such as URL-Ad-10, URL-Ad-55, and URL-Ad-78, that correlate to URL-Ad-1, URL-Ad-5, and URL-Ad-99 the best to display to User-1 instantly (or in real-time). The ads of URL-Ad-10, URL-Ad-55, and URL-Ad-78, are displayed to User-1 when User-1 opens a new web page within the domain of Web Site 40. The number of inputting URLs can be one or more than one, as long as the inputting URLs are viewed by User-1 most recently. The output URLs can be one or more, depending how many the new web page can take.

FIG. 5B shows a table 450′, which is a correlation table of URLs of ads viewed by users of web site 40, in accordance with one embodiment of the present invention. Table 450′ are filled with correlation factors between different URLs and the correlation factors were explained earlier. The correlation factors in the rows of URL-Ad-1 (row-1), URL-Ad-5 (row-5), and URL-Ad-99 (row-5) are added together to generated a sum in the bottom row of FIG. 5B. The URLs with highest numbers in this row (row SUM), excluding the numbers for URL-Ad-1, URL-Ad-5 and URL-Ad-99 (row-99), are selected to be the URLs most correlated to URL-Ad-1, URL-Ad-5, and URL-Ad-99. The numbers for URL-Ad-1, URL-Ad-5 and URL-Ad-99 (row-99) are excluded because they are the inputting URLs and would have the highest values anyway. In the example here, URL-Ad-10, URL-Ad-55, and URL-Ad-78 are three URLs that have the highest sum values of correlation factors. In one embodiment, ads of URL-Ad-10, URL-Ad-55, and URL-Ad-78 are returned to User-1 to appear on a new web page that is opened for User-1. Please note that the method and calculation described above are just examples, other methods and calculation following the same inventive concept can apply too. Alternatively, one or more of the recently viewed ads, such as ads of URL-Ad-1, URL-Ad-5, and URL-Ad-99, can be returned along with one or more of the identified most correlated ads, such as ads of URL-Ad-10, URL-Ad-55, and URL-Ad-78.

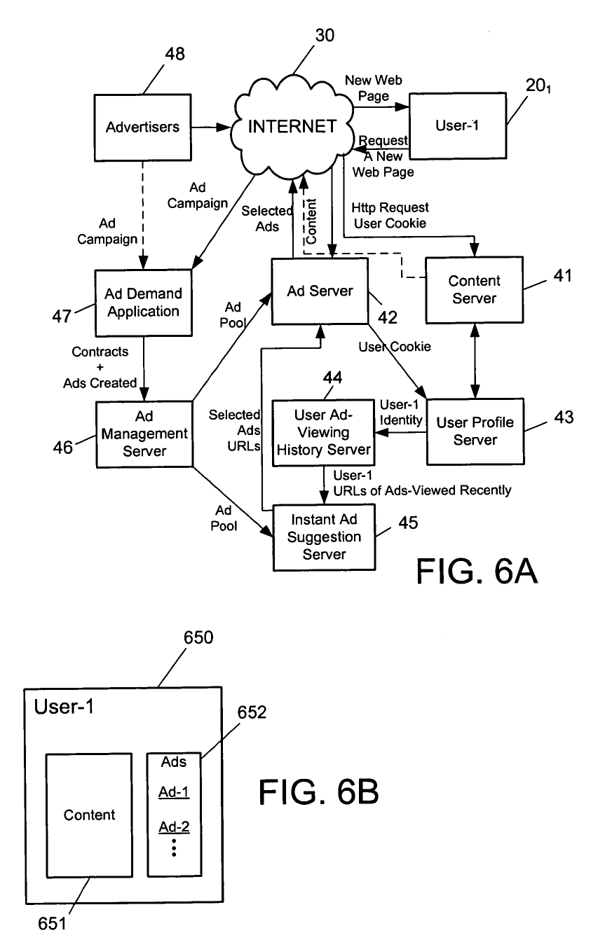

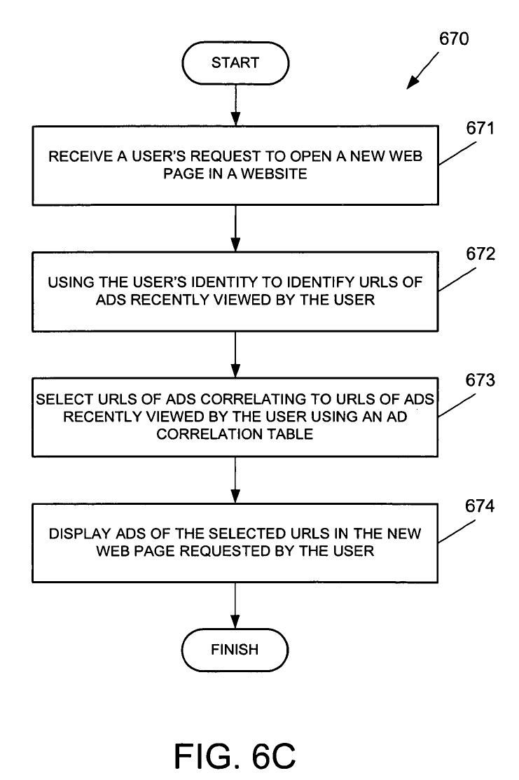

FIG. 6A shows an ad selection system 600 with key components of selecting ads for an user, User-1, and how the key components work with each other, in accordance with one embodiment of the present invention. User-1 accesses web site 40 through Internet 30 to request opening up a new web page 650, as shown in FIG. 6B, to browse. The request, which is an http request, for the new web page 650 is sent a Content Server 41 and an ad server 42, of web site 40. The content server 41 prepares content 651 to be shown on the web page 650, as shown in FIG. 6B. The Ad Server 42 prepares ads 652 to be shown along with content 651 in the web page 650. The embodiments of system and method described here deal with selecting ads that correlate to the current interests of User-1. Ad server 42 prepares ads that correlate to the current interests of User-1. To prepare ads correlating to the current interests to User-1, Ad Server 42 needs to know which ads correlate to the current interests of User-1. Ad server 42 passes the user cookie of User-1 to User Profile Server 43 to identify the user who is requesting a new web page. After the User Profile Server 43 identifies the user being User-1, the identity of User-1 is sent to User Ad-Viewing History Server 44, which sent a number of URLs of ads most recently viewed by User-1 to the Instant Ad Suggestion Server 45.

In addition to taking inputs URLs from the User Ad-Viewing History Server 44, the Instant Ad Suggestion Server 45 also takes ad pool, which contains information of which ads are being sponsored by advertisers and the priorities of the sponsored ads, from ad management server 46. Advertisers 48 access Ad Demand Application 47, which is an application for advertisers to enter advertisement demands, to enter their ad campaigns (or demands). In one embodiment, the Ad Demand Application 47 resides in a server. The Ad Demand Application 47 takes care of issues related to contracts between the web site 40 and the advertisers 48 and the ads created by the advertisers. The finished contracts and prepared ads are delivered and stored in the Ad Management Server 46, which provides ad pool to the Instant Ad Suggestion Server 45. The Instant Ad Suggestion Server 45 utilizes the ad correlation table 450 (or 450′) described above, the cookie identifying the user (User-1 in this case), URLs of ads User-1 recently visited and the ad pool from the Ad Management Server 46 to determine which ads to be selected to be displayed to User-1. The correlation table 450 or 450′ is stored in the Instant Ad Suggestion Server 45.

The Instant Ad Suggestion Server 45 can assign different weights to different ads based on a number of factors, such as the priority, the availability, and the price paid for the ads. The different inputting URLs of ads viewed by User-1 also can have different weights. For example an ad that has viewed more recently can have a higher weight than an ad that has been viewed days ago. In addition, an ad that User-1 spends longer time to view can have a higher weight than an ad viewed for a shorter time period. Once the Instant Ad Suggestion Server 45 takes all these inputs and factors into account to make computation to select correlated ads to display to User-1. The selected ads (represented by URLs) and the user's identity are returned to Ad Server 42 to prepare ads 652 to display in the web page 650 for User-1. The Content Server 41 prepares content to be displayed to User-1. In one embodiment, the Content Server 41 interacts with User Profile Server 43 to prepare contents specific to User-1.

The ads 652 displayed to User-1 are selected based on correlation between a large of users to find similarities and patterns in ad-viewing behaviors or tendencies and also based User-1's recent ad-viewing activities in real time. The selected ads are much more likely to match User-1's current interests and to get User-1's attention to view them than ads selected based on broad user targeting of conventional methods.

FIG. 6C shows a process flow 670 of a user, such as User-1, accessing a web page with ads, which are selected by correlating User-1's recent ad-viewing activities with ad-viewing activities of other users, in accordance with one embodiment of the present invention. At step 671, a user's, such as User-1's, request to open a web page is received by a web site. At step 672, the user's identity is used to identify URL(s) of Ad(s) recently viewed by the users. In one embodiment, the user's identity is sent to a server with users' profiles, such as cookies, geographical location, email address, gender, education, etc. Once the user is identified, the information is passed on to a user ad-viewing history server, which stores ad-viewing data of all users to the web site. The user ad-viewing history server can provide URLs of ads recently viewed by the user. The URLs of ads recently viewed by the user can identify the user's current interests in ads. The ads recently viewed by the user can be ads viewed within the last few seconds, last few minutes, last few days, or last few weeks.

Using the ads recently viewed by the user as inputs is a good idea. User's thought likely stay on the subject for a while, therefore, the user is likely to view correlated ads. Even if the user's thought has drifted off to another subject and the user ignores the correlated ads displayed to him/her. Once the user clicks on one or more ads from another subject, these newly clicked ads can be sent to find correlated ads for the user to keep the user's attention on the related subjects.

At step 673, URLs of ads to be displayed to the user are selected by using the URLs of ads recently viewed by the user, and an ad correlation table that correlates URLs of ads viewed by users to the web site. Calculation is performed to determine which URLs of ads most correlate to the URLs of ads recently viewed by the user. In one embodiment, the ad pool provided by advertisers is included in the ad selection and determination. The ad pool identifies which ads are sponsored and at what priorities. The correlation table could select a number of ads that most correlated to the ads viewed by the user. One or more of the selected ads might no longer be sponsored by the advertisers. Under such a circumstance, the ads not sponsored would not be selected. Other most correlated and sponsored ads would be selected. In addition, some sponsor might pay more than others for their ads. In this case, ads that would bring in more income to the web site might get higher weights than ads that would bring in less income. The weight can be added in before or after the correlation calculation is done. For example, if a number of correlated and sponsored ads are selected, the ads that bring in more income can appear at a higher and more visible position than ads that bring in less income. Ads brining in more income are assigned with higher weights; therefore, An ad with higher weight would move up in the order of selected ads. However, the ads still need to be correlated to the ads recently viewed by the user to be selected. Selecting the URLs of ads to display is performed in real time when the user's request to open the web page at step 671 is received. At step 674, the selected ads are displayed to the user in the web page opened by the user.

The methods and systems described above for selecting advertisements that correlate to advertisements recently viewed by users can make advertisement selection in real time. While users are accessing a web site, the users' ad-viewing activities can be sent over the Internet to the web site. The web site utilizes users' latest ad-viewing activities to select advertisements that correlate to the users' latest (or most recent) ad-viewing activities, which can occur within a few seconds, a few minutes, a few days, or a few weeks. The advertisements are selected in real time and correlate to users' current interests; therefore, users are very likely to view them. In addition, the correlation utilizes ad-viewing histories of many other users to find patterns and similarities, which increase the likelihood of users' viewing of the selected ads. The correlation is performed by computation and does not involve human interpretation during the process, which is different from behavior targeting. The methods and systems are scalable to meet demands of large amount of user, such as millions. The methods and systems do not involve reading and/or searching for key words in the advertisements viewed by the users; therefore the process is simpler, and the time and resources required are smaller compared to methods and systems reading and/or searching for key words in the ads.

The methods and systems described above are mainly for selecting advertisements to display in web pages for users. The concept of selecting advertisements that correlate to users' latest ad-viewing activities can be extended to selecting contents to display to users. Similar to advertisements, contents (or informational contents) can also be identified by URLs. When users click to view contents, their content-viewing histories can also be recorded. In a manner similar to ad-viewing discussed above, content-viewing data by users can also be correlated to find similarities and patterns. A content-viewing table similar to tables 450, 450′, discussed above, can be constructed. URLs of contents recently viewed by a user can be used as inputs to find (or select) most correlated contents for the user in real time. The selected contents can be displayed to the user. Selecting contents correlated to contents recently viewed by the to display to the user increase the likelihood and duration the user stay at the current web site. In a manner similar to ads, web sites can assign a cost to the contents being viewed by the users and make profit in this manner.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of selecting at least one advertisement to display in a web page of a user of a web site, comprising:
receiving the user's request to open the web page of the web site;
sending an identity of the user to identify a Uniform Resource Locator (URL) of at least one advertisement recently viewed by the user;
selecting a correlated URL of the at least one advertisement to display in the web site, wherein the correlated URL of the at least one advertisement correlates to the identified URL of the at least one advertisement recently viewed by the user using an ad correlation table of advertisements viewed by users of the web site; and
displaying the at least one advertisement of the correlated URL being selected in the web page of the user of the web site.

2. The method of claim 1, wherein selecting the correlated URL is performed in real time when the user's request to open the web page is received.

3. The method of claim 1, wherein ad pool created by advertisers is also used in selecting the correlated URL of the at least one advertisement to display in the web page.

4. The method of claim 3, wherein there are more than one correlated URLs of advertisements being selected to display in the web page, the priority of the selected advertisements in the ad pool affecting the location of the selected advertisements being displayed.

5. The method of claim 1, wherein there are more than one identified URLs of advertisements recently viewed by the user.

6. The method of claim 5, wherein the more than one identified URLs of advertisements recently viewed by the user are weighted by the sequence the advertisements being viewed.

7. The method of claim 1, wherein the ad correlation table uses the number of visits by users of the web site to each advertisement to correlate URLs of advertisements viewed by users of the web site.

8. The method of claim 7, wherein the correlation between two advertisements is represented by a correlation factor, with the correlation factor close to 1 being very correlated and the correlation factor close to zero being least correlated.

9. The method of claim 1, wherein the at least one advertisement recently viewed by the user is viewed within last few minutes.

10. A system for selecting advertisements to display in a web page of a user of a web site, comprising:
a user profile server for identifying the user;
a user ad-viewing history server for storing ad-viewing histories of users to the web site, wherein the user ad-viewing history server provide Uniform Resource Locators (URLs) of advertisements recently viewed by the user;
an instant advertisement suggestion server having an ad correlation table that correlates advertisements viewed by users of the web site, wherein the instant advertisement suggestion server takes URLs of advertisements recently viewed by the user as inputs and uses the ad correlation table to select correlated URLs of advertisements to be displayed in the web page correlating with URLs of advertisements recently viewed by the user; and
an ad server using the correlated URLs of advertisements being selected to prepare advertisements to display in the web page of the user.

11. The system of claim 10, further comprising:
an advertisement management server managing advertisement pool created by advertisers, wherein the advertisement management server supply the ad server advertisements to be displayed.

12. The system of claim 11, wherein the instant advertisement suggestion server takes advertisements and priorities of advertisements in the advertisement pool as inputs in selecting correlated URLs of advertisements to be displayed in the web page.

13. The system of claim 11, further comprising:
an advertisement demand application, wherein advertisers can enter their advertisement campaign, the advertisement demand application preparing contracts with the advertisers and storing advertisements sent by the advertisers.

14. The system of claim 10, further comprising:
a content server, wherein the content server prepares contents appearing in the web page along with the advertisements displayed in the web site.

15. The system of claim 10, wherein the instant advertisement suggestion server is configured to select correlated URLs of advertisements correlating with URLs of advertisements recently viewed by the user in real time.

16. The system of claim 10, wherein the ad correlation table is created ahead of time.

17. Computer readable media including program instructions for selecting at least one advertisement to display in a web page of a user of a web site, comprising:
program instructions for receiving the user's request to open the web page of the web site;
program instructions for sending an identity of the user to identify a Uniform Resource Locator (URL) of at least one advertisement recently viewed by the user;
program instructions for selecting a correlated URL of the at least one advertisement to display in the web site, wherein the correlated URL of the at least one advertisement correlates to the identified URL of the at least one advertisement recently viewed by the user using an ad correlation table of advertisements viewed by users of the web site; and
program instructions for displaying the at least one advertisement of the correlated URL being selected in the web page of the user of the web site.

18. The computer readable media of claim 17, wherein ad pool created by advertisers is also used in selecting the correlated URL of the at least one advertisement to display in the web page.

19. The computer readable media of claim 18, wherein there are more than one correlated URLs of advertisements selected to display in the web page, the priority of the selected advertisements in the ad pool affecting the location of the selected advertisements being displayed.

20. The computer readable media of claim 17, wherein the ad correlation table uses the number of visits by users of the web site to each advertisement to correlate URLs of advertisements viewed by users of the web site, and wherein the correlation between two advertisements is represented by a correlation factor, with the correlation factor close to 1 being very correlated and the correlation factor close to zero being least correlated.
